(19) United States
(12) Patent Application Publication
(10) Pub. No.: US 2015/0067185 A1
(43) Pub. Date: Mar. 5, 2015

(54) SERVER-SIDE SYSTEMS AND METHODS FOR REPORTING STREAM DATA

(71) Applicant: AKAMAI TECHNOLOGIES, INC., Cambridge, MA (US)

(72) Inventors: Shaun H. Tamblin, San Jose, CA (US); Eugene Y. Zhang, San Jose, CA (US); Prasad Nadig, Bangalore (IN)

(73) Assignee: AKAMAI TECHNOLOGIES, INC., Cambridge, MA (US)

(21) Appl. No.: 14/017,746

(22) Filed: Sep. 4, 2013

(51) Int. Cl. H04N 21/24; H04N 21/234

(52) U.S. Cl. CPC H04N 21/2407; H04N 21/234
USPC 709/231

(57) ABSTRACT

According to the disclosure hereof, the functionality of a server can be extended to collect data on content streams that the server is delivering to clients, and to beacon certain data back an analytics system to facilitate monitoring of, reporting on, and analysis of the delivery of content streams. At various stages of the streaming process, a server can read and update state information (for example cookie data) on the requesting client reflecting, for example, status in playing a particular stream. Based on the client's requests and the state information at each stage, the server can beacon appropriate information about the stream and its playback status back to the analytics system. The teachings hereof are particularly useful, without limitation, in streaming media analytics and for segment-based streaming approaches, including over HTTP.

This patent document contains material which is subject to copyright protection. The copyright owner has no objection to the facsimile reproduction by anyone of the patent document or the patent disclosure, as it appears in Patent and Trademark Office patent files or records, but otherwise reserves all copyright rights whatsoever.

### BACKGROUND

1. Technical Field

This patent document relates generally to the delivery of content over computer networks, including in particular streaming content from a server to a client, and to the monitoring, reporting, and analysis of such content delivery.

2. Brief Description of the Related Art

Streaming content from a server to a client device is known in the art, and is often used for delivering media, such as streaming audio or video. A variety of techniques are known for streaming both live content and on-demand content. For example, real-time message protocol (RTMP) provides a way for a media server to send content to a client over one or more virtual channels and a control channel. More recently, HTTP-based streaming has become more widely used. Typically, with HTTP based streaming, a given media stream is represented by multiple chunks Or segments which can be requested independently by a client player. Each segment is downloaded by the client and then played in order. In order to know what the segments are available and where to find them (e.g., the URN to use for requesting them), a client generally first obtains a file like a playlist or manifest, which contains the segment locations or indicates how to construct the segment locations (e.g., how to construct the URIs).

For example, HTTP Live Streaming (MS) is a framework that provides for a master playlist, media playlist, and media segments. A master playlist contains references to one or More media playlists. Typically, the master playlist contains references (URIs) to different versions of the same stream, each represented for example by a different media playlist. This can be used to provide streams having different resolutions or at multiple different bitrates, and a client can choose amongst them. A client player may dynamically choose an appropriate bitrate based on network conditions, buffer size/status, and/or device processing power, so as to effect adaptive bitrate streaming.

In HLS, a media playlist references (typically by URI) the media segments that make up the stream for the given bitrate, resolution, or the like, and allow the client player to individually request each segment. Like master playlists, media playlists may be implemented as m3u8 files. Media segments contain the actual media data (e.g., video, audio, multimedia container file). For HLS, the media segments are often MPEG-2 transport streams, designated as is files.

Other segmented streaming based approaches include HTTP Dynamic Streaming, Smooth Streaming and MPEG-DASH.

To serve a stream, a given server or collection of replicated servers can be used to stream the content to requesting client devices in accord with the protocols described above. In some cases, however, a distributed computing system such as a “content delivery network” (CDN) is used to stream content across the Internet. A CDN is typically operated and managed by a service provider, who provides the content delivery service on behalf of third parties. A “distributed system” of this type typically refers to a collection of autonomous computers linked by a network or networks, together with the software, systems, protocols and techniques designed to facilitate various services, such as content delivery or the support of outsourced site infrastructure. This infrastructure is shared by multiple tenants, the content providers. The infrastructure is generally used for the storage, caching, or transmission of content—such as streaming media, but potentially also web pages and applications—on behalf of such content providers or other tenants. The platform may also provide ancillary technologies used therewith including, without limitation, DNS query handling, provisioning, data monitoring and reporting, content targeting, personalization, and business intelligence.

In a known system such as that shown in FIG. 1, a distributed computer system 100 is configured as a CDN and has a set of machines 102 distributed around the Internet. Typically, most of the machines are servers located near the edge of the Internet, i.e., at or adjacent end user access networks. A network operations command center (NOCC) 104 may be used to administer and manage operations of the various machines in the system. Third party sites affiliated with content providers, such as web site 106, offload delivery of content to the distributed computer system 100 and, in particular, to the CDN servers (which are sometimes referred to as “edge” servers in light of the possibility that they are near an “edge” of the Internet). Such servers may be grouped together into a point of presence (POP) 107 at a particular geographic location.

The CDN servers are typically located at nodes that are publicly-routable on the Internet, within or adjacent nodes that are located in mobile networks, in or adjacent enterprise-based private networks, or in any combination thereof.

Typically, content providers offload their content delivery by aliasing (e.g., by a DNS CNAME) given content provider domains or sub-domains to domains that are managed by the service provider's authoritative domain name service. The server provider's domain name service directs end user client machines 122 that desire content to the distributed computer system (or more particularly, to one of the CDN serves in the platform) to obtain the content more reliably and efficiently. The CDN servers respond to the client requests, for example by fetching requested content from a local cache, from another CDN server, from the origin server 106 associated with the content provider, or other source.

Although not shown in detail in FIG. 1, the distributed computer system may also include other infrastructure, such as a distributed data collection system 108 that collects usage and other data from the CDN servers and passes that data to other back-end systems 110, 112, 114 and 116 to facilitate monitoring, logging, alerts, billing, management and other operational and administrative functions. Distributed network agents 118 monitor the network as well as the server loads and provide network, traffic and load data to a DNS query handling mechanism 115. A distributed data transport mechanism 120 may be used to distribute control information (e.g., metadata to manage content, to facilitate load balancing, and the like) to the CDN servers. The CDN may include a network storage subsystem (sometimes referred to herein as “NetStorage”) which may be located in a network datacenter accessible to the CDN servers and which may act as a source of content, such as described in U.S. Pat. No. 7,472,178, the disclosure of which is incorporated herein by reference.

As illustrated in FIG. 2, a given machine 200 in the CDN comprises commodity hardware (e.g., a microprocessor) 202 running an operating system kernel (such as Linux® or variant) 204 that supports one or more applications 206. To facilitate content delivery services, for example, given machines typically run a set of applications, such as an HTTP proxy 207, a name server 208, a local monitoring process 210, a distributed data collection process 212, and the like. The HTTP proxy 207 typically includes a manager process for managing a cache and delivery of content from the machine. For steaming media, the machine may include one or more media servers, such as a Windows® Media Server (WMS) Or Flash server, as required by the supported media formats.

In a typical operation, a content provider identifies a content provider domain or sub-domain that it desires to have served by the CDN. The CDN service provider associates (e.g., via a canonical name, or CNAME, or other aliasing technique) the content provider domain with a CDN hostname, and the CDN provider then provides that CDN hostname to the content provider. When a DNS query to the content provider domain or sub-domain is received at the content provider's domain name servers, those servers respond by returning the CDN hostname. That network hostname points to the CDN, and that hostname is then resolved through the CDN name service. To that end, the CDN name service returns one or more IP addresses. The requesting client application (e.g., browser) then makes a content request (e.g., via HTTP or HTTPS) to a CDN server machine associated with the IP address. The request includes a host header that includes the original content provider domain or sub-domain. Upon receipt of the request with the host header, the CDN server checks its configuration file to determine whether the content domain or sub-domain requested is actually being handled by the CDN. If so, the CDN server applies its content handling rules and directives for that domain or sub-domain as specified in the configuration. These content handling rules and directives may be located within an XML-based “metadata” configuration file, as described in U.S. Pat. No. 7,240,100, the teachings of which are hereby incorporated by reference.

The CDN platform can be considered an overlay across the Internet on which communication efficiency can be improved. Improved communications on the overlay can help when a CDN server needs to obtain content from an origin server 106, or otherwise when accelerating non-cacheable content for a content provider customer. Communications between CDN servers and/or across the overlay may be enhanced or improved using improved route selection, protocol optimizations including TCP enhancements, persistent connection reuse and pooling, content & header compression and de-duplication, and other techniques such as those described in U.S. Pat. Nos. 6,820,133, 7,274,658, 7,607,062, and 7,660,296, among others, the disclosures of which are incorporated herein by reference.

For live and on-demand streaming delivery, the CDN may include a delivery subsystem leveraging the CDN platform, such as described in U.S. Pat. No. 7,296,082, and U.S. Publication Nos. 2011/0173345 and 2012/0265853, the disclosures of which are incorporated herein by reference.

Regardless of the particular delivery infrastructure, a streaming content provider often wants to know certain things about the delivery of their content to end-users. For example, the size of the audience for a particular stream, how many plays a stream receives, and other audience metrics may all be important. Quality of service metrics, such as how often a user re-started a stream—also may be important. In some cases, stream metrics can be obtained using a client-beaconing system, in which a client player sends information about the stream it is playing to some designated machine, which processes this information to generate aggregate statistics on the stream. However, this requires adapting each client player to have appropriate logic, and the universe of players is constantly changing and expanding.

It would be advantageous to have a solution that is able to provide stream monitoring and reporting and analysis capabilities based on collecting data from the server side, without relying on a beacon sent from the client player. It would be advantageous to have such solution compatible with recent technologies for streaming, such as HTTP streaming and/or other chunk/segment based streaming. Collecting data on such streams at the server is challenging because the server generally has limited knowledge about an individual stream, as it is typically receiving a multitude of requests from various clients for various segments of streams.

The teachings herein address these needs and also provide other benefits and improvements that will become apparent in view of this disclosure. The teachings herein may be used by a CDN to provide a monitoring and reporting and analytics system for its participating content providers, but they are not limited to the CDN use case, as they may be implemented in conjunction with any streaming content system.

### SUMMARY

This patent document describes, among other things, systems and methods for collecting and reporting stream data to facilitate monitoring of, reporting on, and analysis of the delivery of content streams. In particular, systems and methods are described herein for collecting and reporting data related to quality-of-service and audience statistics for streaming media, though other use cases are possible.

In one implementation of the teachings hereof, servers that are streaming content to client players are modified to collect data about the streams. The servers may be CDN servers, though this is not a limitation. The servers send the data to a back-end analytics system, which aggregates and processes the information.

At various stages of the streaming process, a server can set, update, and read state information on the requesting client reflecting, for example, its status in playing a particular stream. Based on the client's request and such state information at each stage, the server can beacon appropriate information about the stream back to the analytics system. The state information can be stored on the client in cookies or using other client-side storage mechanisms, including other standards-based approaches that enable a client to store and return state information with requests to servers, either with or without server request. The teachings hereof apply without limitation to streaming media analytics, and to segment-based streaming approaches including over HTTP.

Assume, for example, that a client player requests a master playlist for an HLS stream from a server. When the server receives the request, the server can read state information (e.g., from the HTTP cookie) on the client, if it exists, or if not, generate and set the state information. The state information might include such kinds of information as a client identifier, user identifier, a stream identifier (e.g., which might be name of master playlist or derived from it), a time stamp, and/or other things, as will be described in more detail later in this document. The server can respond to the client request, and the server can also generate and send a beacon message to the analytics system in light of the client request.

Assume the client then sends a request for a media playlist. The server can read the previously stored state information, update it to reflect current status, and use the information in the request (including the state information) to generate another beacon. Likewise, the receipt of requests for media segments of the stream can cause the server to read and update the state information on the client, and generate beacons.

The beacon messages can indicate a variety of information at each stage, e.g., indicating perhaps that the client is attempting to play or playing the stream, the status of the playback, identifying the media strewn being played, identifying what version of the stream (bitrate), and/or other relevant data. As indicated above, the server can send these messages at certain points (e.g., upon receiving the particular requests for playlists, or media segments, or at certain intervals, etc.) to the analytics system. Hence this approach can be used as an alternative or supplement to client-side systems in which a client application (player) with a plugin or other logic periodically beacons information to the back-end analytics system, potentially alleviating the need for integrating such logic into all client player applications.

The specific timing and messaging implementation will typically vary with the design goals and the streaming protocol. Thus, the teachings hereof apply to streams or circumstances that employ one playlist, rather than the HLS approach of master and media playlist used in the example above. For example, the teachings can also be applied to HTTP Dynamic Streaming (HDS), Smooth Streaming, or MPEG-DASH, which generally use a reference file referred to as a manifest rather than a playlist.

The teachings hereof also apply to situations where a client makes a series of media segment requests, irrespective of playlist/manifest requests. For example, the server may send beacons in response to media segment requests, updating and setting the client state information after each such request.

As those skilled in the art will recognize, the foregoing description refers to examples of the invention and is not necessarily meant to reflect all possible embodiments. Other embodiments are described and/or will be apparent in view of the description below and in light of one skilled in the art's understanding of this disclosure. The teachings hereof may be realized in a variety of systems, methods, apparatus, and non-transitory computer-readable media.

### BRIEF DESCRIPTION OF THE DRAWINGS

The teachings of this document will be more fully understood from the following detailed description taken in conjunction with the accompanying drawings, in which:

FIG. 1 is a diagram illustrating one embodiment of a known distributed computer system configured as a content delivery network (CDN);

FIG. 2 is a diagram illustrating one embodiment of a machine on which a content delivery network server in the system of FIG. 1 can be implemented;

FIG. 3 is a diagram illustrating one embodiment of a system for stream monitoring, reporting and analytics;

FIG. 4 illustrates one embodiment of a message sequence amongst certain machines shown in FIG. 3;

FIG. 5 is a diagram illustrating one embodiment of logic process flow in the server 302 shown in FIG. 3; and,

FIG. 6 is a block diagram illustrating hardware in a computer system that may be used to implement the teachings hereof.

### DETAILED DESCRIPTION

The following description sets forth embodiments of the invention to provide an overall understanding of the principles of the structure, function, manufacture, and use of the methods and apparatus disclosed herein. The systems, methods and apparatus described herein and illustrated in the accompanying drawings are non-limiting examples; the claims alone define the scope of protection that is sought. The features described or illustrated in connection with one exemplary embodiment may be combined with the features of other embodiments. Such modifications and variations are intended to be included within the scope of the present invention. The allocation of functions to particular computer machines is not limiting, as the functions recited herein may be combined or split amongst different machines in a variety of ways. All patents, publications and references cited herein are expressly incorporated herein by reference in their entirety.

### Introduction

According to this disclosure, a system of servers can collect and beacon data about streams they are delivering. The data can be beaconed to a back-end analytics system, so as to facilitate monitoring of, reporting on, and analysis of the content streams for a stream content provider. The back-end analytics system aggregates data from many beacons to determine and report on quality-of-service, audience size, audience engagement, viewing duration, and other audience-related metrics, client player statistics, and other information. Hence, this system can be used to provide real-time and/or post-event reporting of content streams.

Preferably the content streams are media streams delivering audio, video, or multimedia (e.g., container files with encoded audio/video presentations) to a client. Preferably the media streams are segmented media streams using a manifest or playlist(s) to define the location of stream segments. Non-limiting examples of suitable streaming protocols include HTTP Live Streaming (HLS), HTTP Dynamic Streaming (HDS), and Smooth Streaming, and MPEG-DASH. The server-side beaconing approach described in this disclosure alleviates the need for client-side code or integration of plugin or other logic into the client, which is advantageous given the ever-increasing array of client players in use.

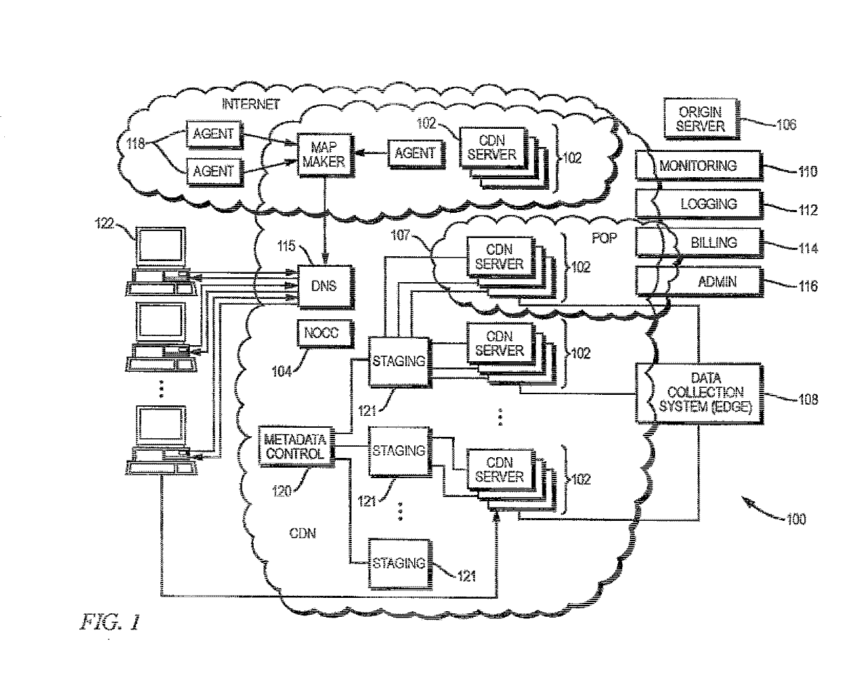

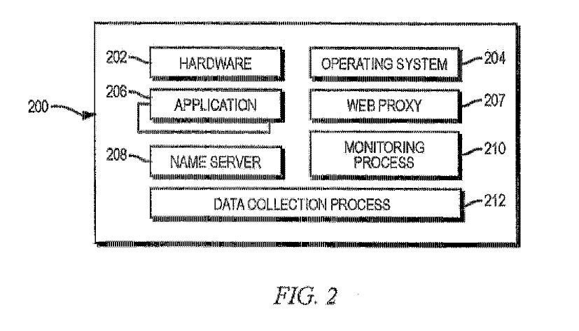

The teachings hereof may be implemented in a content delivery network server used for streaming content, or more particularly, in the HTTP proxy servers described earlier with respect to FIGS. 1-2. More specifically, the proxy server application running in the machine 200 can be modified in accordance with the teachings hereof to provide the disclosed functionality.

### System Architecture

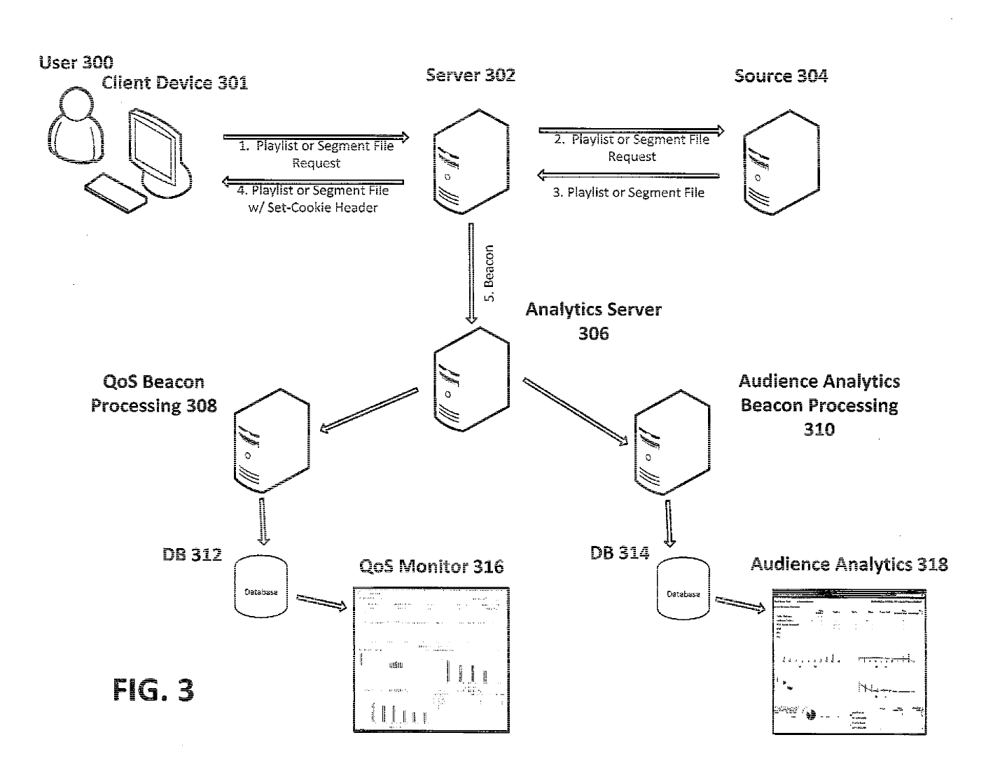

FIG. 3 illustrates one non-limiting embodiment of a system for server-side collection of stream data In the following description, conventions and nomenclature associated with HTTP and HTTP live streaming (HLS) will be used for illustrative purposes; however, the approach would apply equally for other segmented streaming protocols.

In this embodiment, beaconing logic is placed within content servers that are delivering the streams. The system is designed to have a given content server 302 in the system beacon back relevant information about the stream at certain points in time. The information may be in the comparable format as a client-side plugin generated beacon would generate. In the illustrated embodiment, the logic of when to trigger these beacons is based on server 302 responses to client requests for the master playlist, media playlist, or media segments. In order to keep track of sessions, unique viewers, and determine when to trigger a beacon, two cookies are used in this example. However the number of cookies may vary by implementation.

Turning to FIG. 3, user 300 operates a client device 301 running a client media player application. Assume that the client has already obtained the address of a media server via, for example, DNS lookup made by its local DNS server. (In the case of a CDN, the DNS process may have involved an aliasing process to be pointed to the CDN DNS system, and subsequently a particular machine in the CDN, as described earlier in connection with FIGS. 1-2.)

In FIG. 3, the client issues HTTP requests (e.g., HTTP GET request) for playlist files for a given stream, and then the actual media segments for that stream. (The specific request/response sequence will be discussed in more detail below.) When the server 302 receives a request, it serves the playlist or the media segment from cache, as the case may be, if it has a valid cached copy. If not, the server 302 can go forward in a proxy operation to an origin server or some other remote storage mechanism, designated as source 304. The source 304 responds with the playlist or media segment, as the case may be, and the server 302 transmits it to the client 301 in response to the client's request. When responding, the server 302 sets one or more cookies on the client with state information.

At certain times in this flow, generally after receiving a request for a playlist or media segment, the server 302 can send a beacon to a remote machine 306 running an analytics application. This machine 306 ingests the beacon messages and extracts certain information which it transmits to a quality of service (QoS) machine 308, and other information to an audience analytics machine 310. The QoS machine 308 aggregates and collates the data by stream, storing the data in a database 312 so it may later be queried and used to drive a QoS monitoring application available to content providers via a web portal or other user interface. The audience analytics machine 310 aggregates and collates the data by stream, storing the data in a database 314 so it may later be queried and used to drive an audience analytics monitoring application available to content providers via, e.g., the web portal.

The two cookies used in the current embodiment to store state information are now described.

A CLIENT_VIEWER_COOKIE is a persistent cookie used to determine unique viewers and is set at the top level of the delivery hostname whenever a request is received without this cookie present. In one implementation, it can contain a client viewer identifier generated by a hash of client IP address and random string. The viewer ID is unique and anonymous.

A CLIENT_SESSION_COOKIE is a session cookie used to keep track of individual stream playback sessions and determine when and how to beacon back data. The cookie is set at the path of the requested object down to the stream identifier level, and may include such fields as a unique session ID (e.g., hash value of client viewer ID and current timestamp at the server 302), current timestamp, master playlist name, and an indication of the state of the stream playback, for example.

In this embodiment, the client session ID is set or reset in the following scenarios:
Scenario 1—New Viewer: A playlist request (e.g., master or media playlist) is received without the CLIENT_SESSION_COOKIE present
   Note: If a media playlist request comes in without this cookie it is assumed the user is requesting this media playlist directly and therefore this request can be treated as if it were the ‘master’
Scenario 2—Existing Viewer Requesting New Master Playlist Within Same Event: A master playlist request is received with the CLIENT_SESSION_COOKIE present but the requested master filename does not match the originally requested master filename in the cookie
   Note: There is a predefined regex to differentiate a master playlist filename from a media playlist filename
Scenario 3—Existing Viewer Restarting Stream After Being Idle For More Than N Seconds: A master playlist request is received with the CLIENT_SESSION_COOKIE present AND the requested filename matches the originally requested ‘master’ filename in the cookie AND the timestamp is greater than N seconds, where N is configurable (e.g., N=300 seconds)
   Note: There is a predefined regex to differentiate a master playlist filename from a media playlist filename
   Note: The assumption is that a new master playlist request after a stream has been idle for more than N seconds indicates the user is restarting the stream and therefore it is considered a new session.

Three types of beacons are being sent from the server 302 to the analytics machine 306 in this embodiment: Attempt, Play Started, and Playing. The parameters included in each beacon type are explained below in the Beacons section of this document. A typical HLS request flow includes a master playlist request, one or more media playlist requests, and then multiple media segment requests. The first master playlist request/response triggers the “Attempt” beacon and subsequent master playlist requests are ignored from a beaconing standpoint. The first: media playlist request/response triggers the ‘Play Started’ beacon and all subsequent media playlist requests are ignored from a beaconing standpoint. The first media segment request/response after M seconds (where M is configurable; M might be for example 270 seconds) triggers the “Playing” beacon and all subsequent media segment requests are ignored from a beaconing standpoint for the next M seconds. The process of beaconing every M or more seconds for each stream continues until the stream is stopped and no additional requests are being made.

It is emphasized that a variety of beacon types can be triggered at different points in the request low, still leveraging the teachings hereof, and the teachings hereof are accordingly not limited to any particular beacon type or beacon timing. Typically the specific beacon types will be driven by the particular implementation and design goals. Other beacon types might include: an error beacon (generated and sent by the server 302, for example, when the requested content was not available or caused an error of some sort at the server 302 or at the source 304 as a result of the forward request), a bitrate beacon (generated and sent by the server 302, for example, when the client changes the bitrate of the stream, for example by requesting a media playlist for a different bitrate or media segments of a different bitrate than before, due to adaptive bitrate streaming logic), or a heartbeat beacon (generated and sent by the server 302, for example, in place of Playing beacons but with reduced data payload to lighten downstream system processing burdens). These are merely examples.

Furthermore, the beaconing timing will vary with the particular streaming protocol. For example, in protocols having a single playlist or manifest (such as HDS, Smooth Streaming, etc.), the server 302 can set cookie(s) upon receiving a request for the playlist/manifest, and send a “Play Attempt” beacon. As requests for the segments are received with the cookies, the server 302 can send a “Play” beacon, and update the state information in the cookies. The first request for a segment might result in a “Play Started” beacon instead of a “Play” beacon—but again, the particular beacons will vary.

### System Workflow

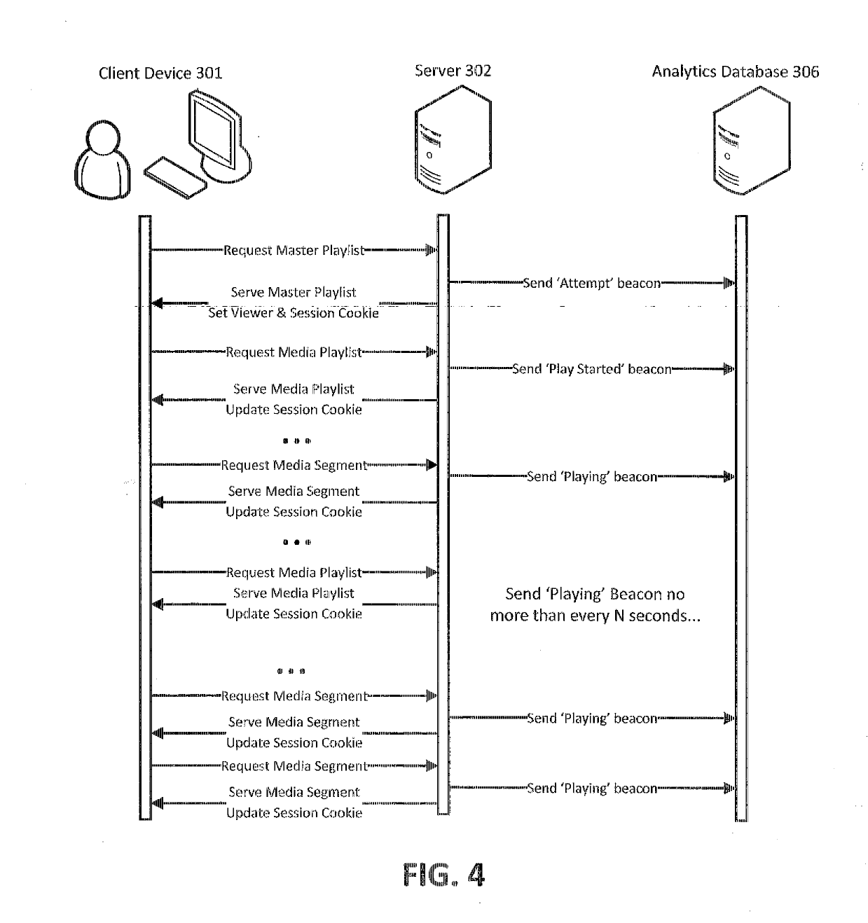

FIG. 4 illustrates the message sequence amongst a client device 301, the content server 302, and the analytics machine 306 in the current embodiment.

The sequence begins with the client device 301 sending a request for a master playlist to the server 302. Assume that the client device 301 does not have a CLIENT_VIEWER_COOKIE or CLIENT_SESSION_COOKIE set. The receipt of the master playlist request triggers the server 302 to send a beacon to the analytics machine 306 with certain information, such as a stream identifier, and an indication that there has been an “Attempt” at playing the stream. (A more detailed list of potential information is in the Beacon section of this document, below.) The server 302 serves the master playlist and sets the cookies, CLIENT_VIEWER_COOKIE and CLIENT_SESSION_COOKIE. The server's 302 retrieval of the playlist file itself, e.g., from local cache or a source 304, is not shown in FIG. 4 but it would also occur. Note that the specific timing of sending the beacon is merely illustrative—it could occur before or after retrieving and serving the requested content, as required by a particular design implementation. It some embodiments, the beacons can include server 302 performance information (such as start/end timestamps or time deltas indicating how long it took the server 302 to respond to the client's request), in which case the server 302 should be configured to send the beacon after sending the response. In other embodiments, the “Attempt” or “Play Started” beacons could even be retained until the media segments were requested, and then sent, so as to avoid sending the beacons if the client aborts the streaming process.

Continuing the sequence shown in FIG. 4, the client device 301 sends a request for a media playlist that appeared on the master playlist. The CLIENT_VIEWER_COOKIE and CLIENT_SESSION_COOKIE are received with this request and, based on the fact that a media playlist request is being made, the information in the media playlist request, and/or information in the cookies, the server 302 generates another beacon to the analytics machine 306. In this example, it sends a beacon indicating “Play Started.” As before, the beacon may contain information from the request and/or cookies. The server 302 updates the CLIENT_SESSION_COOKIE (e.g., with a new timestamp and/or new status indicating that the media playlist had been requested) and sets the updated cookie on the client device, along with serving the requested media playlist.

Note that in some situations or with some protocols, a client device might simply begin by requesting a non-master playlist (in the context of HLS, this would represent a media playlist without an initial request for a master playlist, in the context of HDS, it would represent a manifest request). The logic of the server 302 can accommodate this scenario. The server 302 can set a CLIENT_VIEWER_COOKIE and CLIENT_SESSION_COOKIE, and can send an “Attempt” and/or “Play Started” beacon as a result of such as non-master playlist request.

Next, the client device 301 sends a request for an actual media segment file (such as a .ts file). The server 302 receives this request: along with the CLIENT_VIEWER_COOKIE and CLIENT_SESSION_COOKIE. The request for the media segment triggers the server 302 to send a “Playing” beacon to the analytics machine 306. As before, the beacon may contain information from the request and/or cookies. The cookies are updated to reflect the new status, and the media segment is served to the client device 301. Subsequently a client device requests other media segments, as it is now playing the stream. To avoid overloading the analytics machine 306, the server 302 is configured (in this example) to send the “Playing” beacon no more than every N seconds, which is a configurable value. Thus the server 302 examines the CLIENT_SESSION_COOKIE sent with the media segment request, and based on the timestamp, the server 302 determines whether to send a new “Playing” beacon.

Also shown in FIG. 4 is a second request for a media playlist, e.g., which is intended to illustrate that the client might request a mix of media playlists and/or media segments as the stream is playing. For example, a client may need to switch to another media playlist because it needs to change bitrate (due to an adaptive bitrate streaming decision that the current bandwidth is suboptimal). The server 302 can be configured to track such media playlist changes and beacon accordingly, ignore such subsequent media playlist requests, or alternatively could examine them and check the timestamp, and send a “Playing” beacon if the timestamp is less than N seconds (a configurable value). Implementations will vary.

At some point, the client device 301 stops sending requests for media segments, and the server 302 stops sending “Playing” beacons. This may be because the user has stopped the stream, the user has paused the stream, or the stream is finished.

In this embodiment, the end of the stream is not marked by a beacon from the server 302. The analytics machine 306 or other downstream processing can be configured to treat the end of the beacons as the end of the stream (e.g., after some time T it is assumed that the stream is over). To separate the stopping or pausing of a stream from the normal end of the stream, the server 302 could be configured to send a “Finished” beacon when the client requests a media segment that is known to be the last media segment in a media playlist.

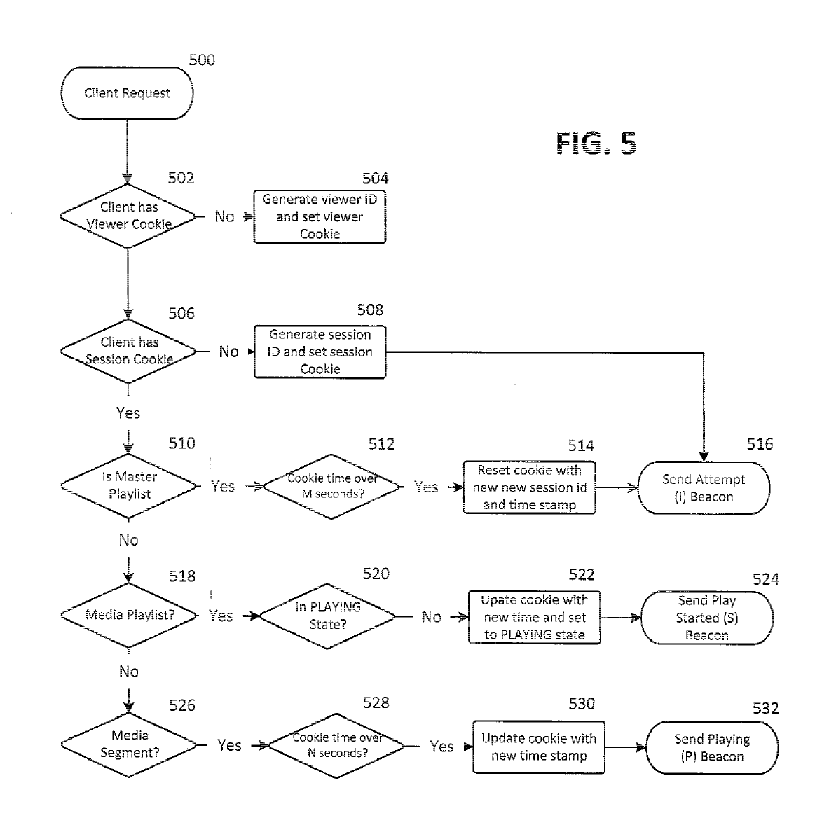

FIG. 5 shows an embodiment of logical flow within a server 302. Not all logic with respect to responding to a client request is shown, but rather certain logical flow useful to illustrate the beaconing process. This process flow starts when the server 302 receives a request (e.g., an HTTP ‘Get’) from a client device (500). The server 302 cheeks whether the client device 300 has a CLIENT_VIEWER_COOKIE (504), and if not, generates and sets the CLIENT_VIEWER_COOKIE on the client, e.g., using the hash approach describe earlier (506). If it is present, the server 302 extracts relevant data such as the viewer id from the CLIENT_VIEWER_COOKIE. The server 302 then checks for a CLIENT_SESSION_COOKIE—if there is none, then the server 302 generates and sets a CLIENT_SESSION_COOKIE on the client (508). The server 302 then sends an “Attempt” beacon. It is assumed in this flow that if there is no CLIENT_SESSION_COOKIE, then it is an initial request which is reflected as an “Attempt” (presumably the request is for a master playlist, but it could be for a media playlist).

Continuing with FIG. 5, lithe CLIENT_SESSION_COOKIE is present, the server 302 extracts relevant data such as the session id. The server 302 cheeks to see what the client is requesting. If the request is for a master playlist (510), the server 302 checks the time stamp from the CLIENT_SESSION_COOKIE (512). If the timestamp is less than M seconds, then this is treated as part of a prior streaming session for which the master playlist is merely being re-requested, so another “Attempt” beacon is not sent. If the timestamp is more than M seconds old (where M is configurable; it might be, e.g., 300 seconds, as noted above), then the request is treated as a new stream request so the CLIENT_SESSION_COOKIE is reset with a new session identifier and the “Attempt” beacon is sent (514, 516).

A request for a media playlist (518) causes the server 302 to check the status stored in the CLIENT_SESSION_COOKIE (520). If the status is not in the ‘playing’ state, then the server 302 updates the CLIENT_SESSION_COOKIE with a new timestamp and sets the status to ‘Playing’ (522). The server 302 sends the “Play Started” beacon (524). If the status is in the ‘Playing’ state, then the media playlist request is treated as a re-request of a media playlist. As mentioned previously, this kind of request could be ignored from a beaconing standpoint, or examined depending on the particular implementation.

A request for a media segment (516) results in the server 302 checking the timestamp of the CLIENT_SESSION_COOKIE to see if it is more than N seconds old (configurable value) (528). As noted above, the value N prevents the server 302 from sending “Playing” beacons too frequently. Hence, if the timestamp is less than N seconds old, the server 302 does not send a beacon. If the timestamp is more than N second old, then, the server 302 updates the timestamp in the CLIENT_SESSION_COOKIE to the current time, and then sends a “Playing” beacon (530, 532).

### Exemplary Pseudo-Code

The following pseudo-code describes the server 502 operation shown in the example of FIG. 5.

Request Handling Configuration

| | |
|---|---|
| 1. | Detect whether the client request is for master playlist |
| 2. | If CLIENT_VIEWER_COOKIE cookie is not preset |

| a. | Compute the client ID hash based on client IP and |
|---|---|
| | random string |
| b. | Set CLIENT_VIEWER_COOKIE downstream |

| | |
|---|---|
| 3. | If CLIENT_VIEWER_COOKIE cookie is present |

| | |
|---|---|
| a. | Extract client ID from the cookie |

| | |
|---|---|
| 4. | If CLIENT_SESSION_COOKIE cookie is not present |

| a. | Generate session ID using CLIENT_VIEWER_ID and |
|---|---|
| | SERVER_CURRENT_TIME hash |
| b. | Set downstream cookie CLIENT_SESSION_COOKIE with |
| | session ID |
| c. | Initialize A_VALUE to I |

| | |
|---|---|
| 5. | If CLIENT_SESSION_COOKIE cookie is present |

| | |
|---|---|
| a. | Extract the time from CLIENT_SESSION_COOKIE |
| b. | If the request is for master playlist |

| | |
|---|---|
| 1. | If time in the CLIENT_SESSION_COOKIE is over |

M seconds old

| | |
|---|---|
| a. | Set A_VALUE to I |
| b. | Reset CLIENT_SESSION_COOKIE with |

updated timestamp (current time)

| | |
|---|---|
| 2. | If the request file name is different than |

the master playlist name inside the
CLIENT_SESSION_COOKIE

| | |
|---|---|
| a. | Set A_VALUE to I |
| b. | Reset CLIENT_SESSION_ COOKIE with new |

master playlist and updated timestamp
(current time)

| | |
|---|---|
| c. | If the request is for media playlist |

| | |
|---|---|
| 1. | If CLIENT_SESSION_COOKIE is NOT in PLAYING |

state

| | |
|---|---|
| a. | Set A_VALUE to S |
| b. | Reset CLIENT_SESSION_COOKIE with update |

timestamp and set the state to “P”

| | |
|---|---|
| 2. | If CLIENT_SESSION_COOKIE is in PLAYING state |

| | |
|---|---|
| a. | Ignore this additional request for |

media playlist

| | |
|---|---|
| d. | If the request is for media segment |

| | |
|---|---|
| 1. | Extract stream bitrate of the request |
| 2. | If CLIENT_SESSION_COOKIE is in PLAYING state |

| | |
|---|---|
| a. | If the session time is over N seconds |

i. Set A_VALUE to P

| | |
|---|---|
| b. | Set down stream CLIENT_SESSION_COOKIE |

with updated time

Beacon-generating configuration

| 1. | Extract and construct event name, device types, application |
|---|---|
| | names, stream name, device type, application name, user |
| | location, timestamp, etc., or other information derived |
| | from the URL or HTTP request to create key-value pairs to |
| | be inserted into appropriate beacon. |
| 2. | If A_VALUE is I |

| | |
|---|---|
| a. | Send I beacon / / [“Attempt” beacon] |

| | |
|---|---|
| 3. | If A_VALUE is S |

| | |
|---|---|
| a. | Send S beacon / / [“Play Started” beacon] |

| | |
|---|---|
| 4. | If A_VALUE is P |

| | |
|---|---|
| a. | Send P beacon / / [“Playing” beacon] |

It should be understood that the particular beaconing logic and flow described above is one example only. As mentioned before, the times and circumstances at which a beacon is generated is usually dependent on particular design goals and implementations, and on the protocol (HLS, HDS, Smooth Streaming) which is being targeted. In some cases, it may make sense to send only subset of the beacons described above, or to supply beacons only triggered by media segment requests, or to adopt some other variant of the examples given above (including sending other/additional types of beacons as taught herein).

### Cookies & Beacons

The following table provides an example implementation of the cookies mentioned in the description above.

| Cookie Name | Type | Attributes |
|---|---|---|
| CLIENT_VIEWER_ID | Persistent | CLIENT_VIEWER_ID- |
| | | Unique ID assign for each |
| | | client |
| CLIENT_SESSION_COOKIE | Session | Sid-Unique ID assign for |
| | | each session |
| | | Timestamp—timestamp of |
| | | last cookie update |
| | | Master—Name of the master |
| | | playlist associated with this |
| | | session |
| | | Status—Status of the session |
| | | (e.g., Attempt, Play Started, |
| | | Playing, Bitrate shift, Error, |
| | | and so on) |

The following table provides an example of the contents of the beacon messages that can be sent by the server 302 to the analytics machine 306.

| Beacon Types | Description | Attributes |
|---|---|---|
| I | Initiate/Attempt | beacon_id = I |
| | | b = [Analytics Report ID] |
| | | s = 0 [Sequence Number] |
| | | en = [Event Name] |
| | | tt = [Stream Title] |
| | | ac = [Requested File Name] |
| | | sa = [Device Type] |
| | | d = [Client Viewer ID] |
| | | c = [Client Session ID] |
| | | al = [Application Type] |
| | | cg = [User Agent] |
| | | geo = [geographic location/country |
| | | code derived from request] |
| S | Play Started | beacon_id = S |
| | | b = [Analytics Report ID] |
| | | s = 1 [Sequence Number] |
| | | en = [Stream Title] |
| | | tt = [Stream Title] |
| | | ac = [Master Playlist Name] |
| | | sa = [Device Buckets] |
| | | d = [Client Viewer ID] |
| | | c = [Client Session ID] |
| | | al = [Application Bucket] |
| | | cg = [User Agent] |
| P | Playing | beacon_id = P |
| | | b = [Analytics Report ID] |
| | | s = 2 [Sequence Number] |
| | | en = [Stream Title] |
| | | tt = [Stream Title] |
| | | ac = [Master Playlist Name] |
| | | sa = [Device Buckets] |
| | | d = [Client Viewer ID] |
| | | c = [Client Session ID] |
| | | rb = [Requested Bitrate] |
| | | al = [Application Bucket] |
| | | cg = [User Agent] |
| | | tt = [Stream Title] |
| | | ac = [Request File Name] |
| | | cg = [User Agent] |

The user agent is an HTTP header that the server 302 can extract from the client request. The user agent string contains information about the client machine and the application that is sending the request. The server 302 can read the user-agent to determine the device and/or application and then place these into predefined categories (e.g., “device type” or “application type”) for the back-end analytics system to use.

For example, the server 302 can map the client request into hardware device buckets representing particular manufacturers, particular models, or device families, or based on operating system, or other categorization of the machine requesting the content. For application types, the server 302 can map the client request into application buckets representing particular players, whether a dedicated media player or a browser, etc., browsers, media frameworks, particular application developers/companies, or other aspect of the application that is requesting the content.

### Examples of Metrics For Reporting/Analytics

The analytics machine 306 and associated processing systems 308, 310 aggregate and process the beacon messages from servers 302 to prepare reports, graphs, charts, and other user displays for the delivered media streams. Based on the beacon data, the system can prepare and display metrics such as:
a. Audience Size
b. Plays
c. Play Duration
d. Audience Size
e. Plays
f. Play Duration
g. Unique Viewers
h. Bitrate Plays—ability to see distribution of requested bitrates, as well as data indicating bitrate upshifts/downshifts, errors, and the like
i. Time
j. Event Name
k. Stream Name (master playlist)
l. Device Type
m. Application Type
n. Other things like network or internet service provider (ISP) where the server 302 is located
o. Geography—down to region/state level
p. Other custom defined dimensions

### Computer Based Implementation

The client devices, servers, and other computer apparatus described herein may be implemented with conventional computer systems, as modified by the teachings hereof, with the functional characteristics described above realized in special-purpose hardware, general-purpose hardware configured by software stored therein for special purposes, or a combination thereof.

Software may include one or several discrete programs. A given function may comprise part of any given module, process, execution thread, or other such programming construct. Generalizing, each function described above may be implemented as computer code, namely, as a set of computer instructions, executable in one or more microprocessors to provide a special purpose machine. The code may be executed using conventional apparatus—such as a microprocessor in a computer, digital data processing device, or other computing apparatus—as Modified by the teachings hereof. In one embodiment, such software may be implemented in a programming language that runs in conjunction with a proxy on a standard Intel hardware Platform running an operating system such as Linux. The functionality may be built into the proxy code, or it may be executed as an adjunct to that code.

While in some cases above a particular order of operations performed by certain embodiments is set forth, it should be understood that such order is exemplary and that they may be performed in a different order, combined, or the like. Moreover, some of the functions may be combined or shared in given instructions, program sequences, code portions, and the like. References in the specification to a given embodiment indicate that the embodiment described may include a particular feature, structure, or characteristic, but every embodiment may not necessarily include the particular feature, structure, or characteristic.

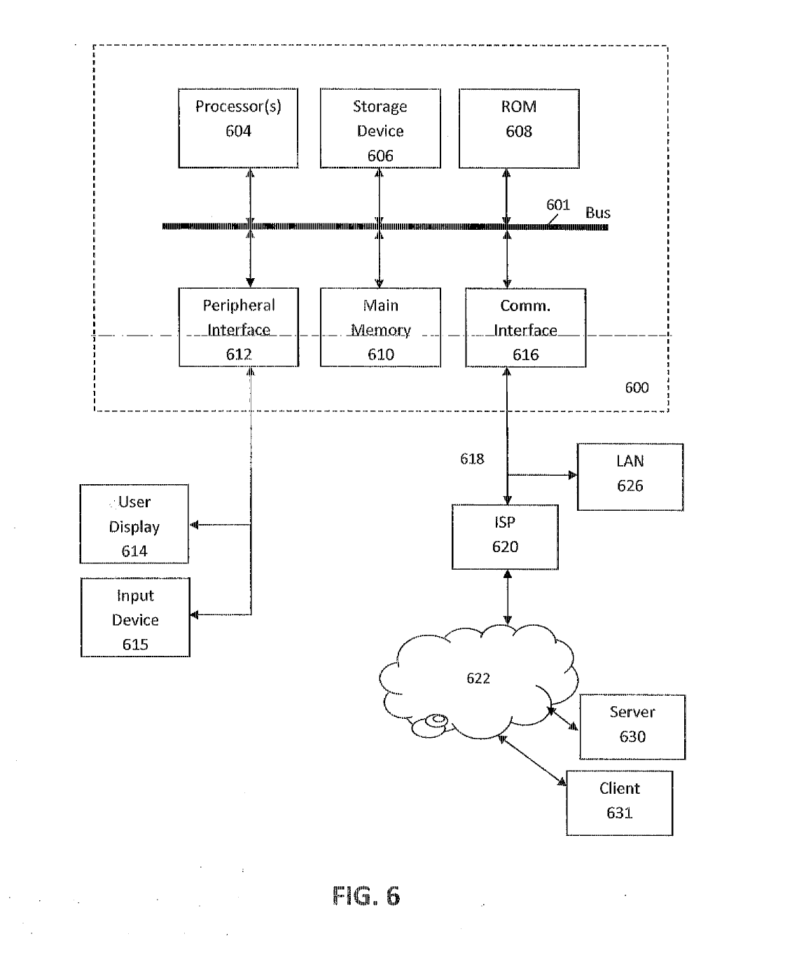

FIG. 6 is a block diagram that illustrates hardware in a computer system 600 in which embodiments of the invention may be implemented. The computer system 600 may be embodied in a client, server, personal computer, workstation, tablet computer, wireless device, mobile device, network device, router, hub, gateway, or other device.

Computer system 600 includes a microprocessor 604 coupled to bus 601. In some systems, multiple microprocessor and/or microprocessor cores may be employed. Computer system 600 further includes a main memory 610, such as a random access memory (RAM) or other storage device, coupled to the bus 601 for storing information and instructions to be executed by microprocessor 604. A read only memory (ROM) 608 is coupled to the bus 601 for storing information and instructions for microprocessor 604. As another form of memory, a non-volatile storage device 606, such as a magnetic disk, solid state memory (e.g., flash memory), or optical disk, is provided and coupled to bus 601 for storing information and instructions. Other application-specific integrated circuits (ASICs), field programmable gate arrays (FPGAs) or circuitry may be included in the computer system 600 to perform functions described herein.

Although the computer system 600 is often managed remotely via a communication interface 616, for local administration purposes the system 600 may have a peripheral interface 612 communicatively couples computer system 600 to a user display 614 that displays the output of software executing on the computer system, and an input device 615 (e.g., a keyboard, mouse, trackpad, touchscreen) that communicates user input and instructions to the computer system 600. The peripheral interface 612 may include interface circuitry and logic for local buses such as Universal Serial Bus (USB) or other communication links.

Computer system 600 is coupled to a communication interface 616 that provides a link between the system bus 601 and an external communication link. The communication interface 616 provides a network link 618. The communication interface 616 may represent an Ethernet or other network interface card (NIC), a wireless interface, modem, an optical interface, or other kind of input/output interface.

Network link 618 provides data communication through one or more networks to other devices. Such devices include other computer systems that are part of a local area network (LAN) 626. Furthermore, the network link 618 provides a link, via an internet service provider (ISP) 620, to the Internet 622. In turn, the Internet 622 may provide a link to other computing systems such as a remote server 630 and/or a remote client 631. Network link 618 and such networks may transmit data using packet-switched, circuit-switched, or other data-transmission approaches.

In operation, the computer system 600 may implement the functionality described herein as a result of the microprocessor executing code. Such code may be read from or stored on a non-transitory computer-readable medium, such as memory 610, ROM 608, or storage device 606. Other forms of non-transitory computer-readable media include disks, tapes, magnetic media, CD-ROMs, optical media, RAM, PROM, EPROM, and EEPROM. Any other non-transitory computer-readable medium may be employed. Executing code may also be read from network link 618 (e.g., following storage in an interface buffer, local memory, or other circuitry).

The client device may be a conventional desktop, laptop or other Internet-accessible machine running a web browser or other rendering engine, but as mentioned above the client may also be a mobile device. Any wireless client device may be utilized, e.g., a cellphone, pager, a personal digital assistant (PDA, e.g., with GPRS NIC), a mobile computer with a smartphone client, tablet or the like. Other mobile devices in which the technique may be practiced include any access protocol-enabled device (e.g., iOS™-based device, an Android™ based device, other mobile-OS based device, or the like) that is capable of sending and receiving data in a wireless manner using a wireless protocol. Typical wireless protocols include: WiFi, GSM/GPRS, CDMA or WiMax. These protocols implement the ISO/OSI Physical and Data Link layers (Layers 1 & 2) upon which a traditional networking stack is built, complete with IP, TCP, SSL/TLS and HTTP. The WAP (wireless access protocol) also provides a set of network communication layers (e.g., WDP, WTLS, WTP) and corresponding functionality used with GSM and CDMA wireless networks, among others.

In a representative embodiment, the mobile device is a cellular telephone that operates over GPRS (General Packet Radio Service), which is a data technology for GSM networks. Generalizing, a mobile device as used herein is a 3G—(or next generation) compliant device that includes a subscriber identity module (SIM), which is a smart card that carries subscriber-specific information, mobile equipment (e.g., radio and associated signal processing devices), a man-machine interface (MMI), and one or more interfaces to external devices (e.g., computers, PDAs, and the like). The techniques disclosed herein are not limited for use with a mobile device that uses a particular access protocol. The mobile device typically also has support for wireless local area network (WLAN) technologies, such as Wi-Fi. WLAN is based on IEEE 802.11 standards. The teachings disclosed herein are not limited to any particular mode or application layer for mobile device communications.

It should be understood that the foregoing has presented certain embodiments of the invention that should not be construed as limiting. For example, certain language, syntax, and instructions have been presented above for illustrative purposes, and they should not be construed as limiting. It is contemplated that those skilled in the art will recognize other possible implementations in view of this disclosure and in accordance with its scope and spirit. The appended claims define the subject matter for which protection is sought.

It is noted that trademarks appearing herein are the property of their respective owners and used for identification and descriptive purposes only, given the nature of the subject matter at issue, and not to imply endorsement or affiliation in any way.

1.-15. (canceled)

16. A computer-implemented method for monitoring delivery of a content stream having a plurality of segments, comprising:
with at least one server that has a microprocessor and a storage device storing computer-readable instructions for execution by the microprocessor:
receiving a first client request for a first segment of a content stream;
receiving first state information from the client device with the first client request, updating the first state information to create second state information, and setting the second state information on the client device;
receiving a second client request for a second segment of the content stream;
receiving the second state information from the client device with the second client request;
generating a message in response to at least one of (i) the first state information and the first client request with the first state information, and (ii) the second client request with the second state information;
sending the message to a remote machine;
wherein the message comprises an identifier of the stream.

17. The method of claim 16, wherein updating the first state information comprises updating any of a timestamp and a playback status.

18. The method of claim 16, wherein the message comprises at least one of: a client identifier, a user identifier, and a playback status.

19. The method of claim 16, wherein the at least one server generates a message in response to (i) the first client request with the first state information, and generates another message in response to (ii) the second client request with the second state information, wherein each of the messages comprise an identifier of the content stream.

20. The method of claim 16, wherein the first state information comprises information stored in one or more cookies, and the second state information comprises updated information stored in the one or more cookies.

21. The method of claim 16, wherein the content stream comprises a media stream.

22. The method of claim 16, wherein the first and second client requests are each HTTP requests.

23. A computer-implemented method for monitoring delivery of a content stream having a plurality of segments, comprising:
with at least one server that has a microprocessor and a storage device storing computer-readable instructions for execution by the microprocessor:
receiving a first client request for a first segment of a content stream;
generating and setting first state information on the client device;
receiving a second client request for a second segment of the content stream;
receiving the first state information from the client device with the second client request, updating the first state information to create second state information, and setting the second state information on the client device;
generating a message in response to at least one of (i) the first client request, and (ii) the second client request with the first state information;
sending the message to a remote machine;
wherein the message comprises an identifier of the stream.

24. The method of claim 23, wherein updating the first state information comprises updating any of a timestamp and a playback status.

25. The method of claim 23, wherein the message comprises at least one of: a client identifier, a user identifier, and a playback status.

26. The method of claim 23, wherein the at least one server generates a message in response to (i) the first client request, and generates another message in response to (ii) the second client request with the first state information, wherein each of the messages comprise an identifier of the content stream.

27. The method of claim 23, wherein the first state information comprises information stored in one or more cookies, and the second state information comprises updated information stored in the one or more cookies.

28. The method of claim 23, wherein the content stream comprises a media stream.

29. The method of claim 23, wherein the first and second client requests are each HTTP requests.
